(19) United States
(12) Patent Application Publication
(10) Pub. No.: US 2007/0186677 A1
(43) Pub. Date: Aug. 16, 2007

(54) NON-CONTACT RF STRAIN SENSOR

(76) Inventors: James L. Zunino III, Boonton Twp, NJ (US); John F. Federici, Westfield, NJ (US); Hee C. Lim, Edison, NJ (US)

Correspondence Address: U.S. ARMY TACOM-ARDEC;ATTN: AMSTRA-AR-GCL, BLDG 3, PICATINNY ARSENAL, NJ, 07806-5000, US

(21) Appl. No.: 11/674,835

(22) Filed: Feb. 14, 2007

Related U.S. Application Data
(60) Provisional application No. 60/766,826, filed on Feb. 14, 2006.

(51) Int. Cl. G01N 3/20

(52) U.S. Cl. 73/849

(57) ABSTRACT

A passive, non-contact radio frequency (RF) strain sensor changes resonant frequency as it is deformed. The sensor's resonant frequency can be determined by monitoring the signals transmitted and/or reflected therefrom upon illumination of the sensor by a known RF signal source. The sensor can be implemented using thin film techniques on a flexible thin substrate that can be attached to the surface of a structural member of interest.

### CROSS REFERENCE TO RELATED APPLICATIONS

This application claims the benefit under 35 U.S.C. § 119(e) of U.S. Provisional Application No. 60/766,826, filed Feb. 14, 2006, the entire contents of which are hereby incorporated by reference for all purposes into this application.

UNITED STATES GOVERMENT INTEREST

The inventions described herein may be manufactured, used and licensed by or for the U.S. Government for U.S. Government purposes.

FEDERAL RESEARCH STATEMENT

The inventions described herein may be made, used, or licensed by or for the United States Government for government purposes without payment of any royalties thereon or therefore.

### FIELD OF THE INVENTION

This invention relates generally to the field of electronic sensors, particularly non-contact sensors and strain sensors.

### BACKGROUND OF THE INVENTION

There is a need to determine the structural integrity of support beams and other related materials and substrates in real-time. A common current practice includes visual inspection. Many structures of interest, however, are often in hard to reach or hidden locations making visual inspection difficult. Other approaches may employ electronic sensor packages. These are often large, space-consuming devices, often accompanied by data storage devices. Furthermore, present sensor systems store data and do not report real-time information and cannot be incorporated into on-board systems or transmitted off-board to prognostic and diagnostic equipment. Moreover, present sensors are often “active” and can cause signature management, communication, and other interference issues. Fiber optics and other similar sensors have been developed but fail to meet certain requirements. Wired Sensors often have interconnect failures, inherent faults, constantly transmit, and require more space.

As such, current practices are expensive, time consuming, require experienced personnel, and are often times inaccurate and not based on real-time data.

### SUMMARY OF THE INVENTION

In accordance with an exemplary embodiment of the present invention, a non-contact, radio-frequency (RF) strain sensor comprises a resistor-inductor-capacitor (RLC) circuit whose natural resonant frequency varies as the sensor is perturbed by an applied load. The exemplary sensor is formed on a decal-like, flexible dielectric substrate that can be attached to a structural member of interest and embedded underneath any type of non-conductive paint.

The wireless RF strain sensor of the present invention can be implemented as a passive device with no power supply attached thereto. The sensor is read by illuminating it with an RF signal and monitoring the signals reflected and/or transmitted by the sensor.

As such, issues with known systems such as battery lifetime support, heating, and wiring problems such as contact engagement etc. are overcome with the present invention. Also, an exemplary sensor in accordance with the present invention is low-cost, light-weight, robust, and easy to attach to hard to reach members. The sensor can also be easily read to provide real-time information on demand using, for example, a non-invasive hand-held device operated from a convenient location, e.g. from outside of a vehicle, even though the sensor may be deeply embedded in the vehicle, in a hard to reach location. Moreover, multiple sensors can be used in a particular application with each sensor being readable individually. Passive operation does not emit or broadcast any active RF signal, either intermediately or continuously to the surroundings, thus making the sensors suitable for discreet or silent mode operations and avoiding interference with other systems with current operations or communications.

Moreover, the ability to sense structural integrity, stress strain, impact, etc. in real-time will facilitate the transition from scheduled maintenance to condition-based maintenance (CBM) and provide logistic staff real-time prognostic and diagnostic information to assist in rapid decision making. The ability to make CBM decisions will help extend the lifetime of numerous platforms and systems.

The aforementioned and other aspects and advantages of the present invention will be apparent from the drawings and the detailed description which follows below.

### BRIEF DESCRIPTION OF THE DRAWINGS

FIG. 1 is a plan view of an exemplary embodiment of a non-contact strain sensor according to the principles of the present invention.

FIG. 2 is a schematic diagram of a lumped-element electrical circuit representation of the sensor of FIG. 1.

FIGS. 3A and 3B are spectral analysis graphs illustrating the shift in resonant frequency for an exemplary sensor of the present invention that is unstretched and stretched, respectively.

FIG. 4 is a schematic illustration of an exemplary arrangement for determining the resonant frequency of a strain sensor in accordance with the present invention.

FIG. 5 is a graph showing the relationship between the output voltage of an exemplary strain sensor in accordance with the present invention and the load applied thereto.

FIG. 6 is a cross-sectional view of an exemplary arrangement of a strain sensor, in accordance with the present invention, on a steel beam.

FIG. 7 is a schematic illustration of an exemplary arrangement of strain sensors, in accordance with the present invention, on a structural member undergoing deformation.

### DETAILED DESCRIPTION

The following illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

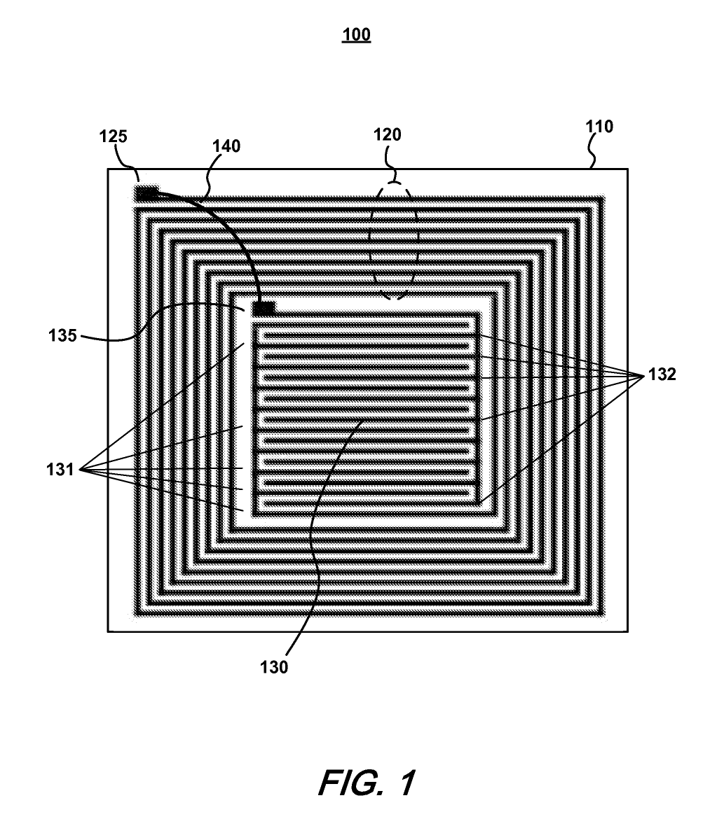

FIG. 1 is a plan view of an exemplary embodiment of a non-contact strain sensor 100 according to the principles of the present invention. The sensor 100 comprises a flexible, dielectric substrate 110 with conductive elements 120, 125, 130 and 135 formed thereon. The conductive elements may be formed using thin-film techniques or the like. Fabrication of the sensor 100 is described in greater detail below. The element 120 comprises a plurality of conductive segments arranged in an inwardly-spiraling pattern of substantially concentric rectangles that begins at the conductive element 125, at an outer end of the pattern, and is coupled to the conductive element 130 at an inner end of the pattern. As discussed below, the element 120 acts primarily as an inductive element and as a resistive element, with some parasitic capacitance. The inductance and resistance may or may not vary as the sensor 100 is flexed or perturbed.

The conductive element 130 comprises two sets 131 and 132 of substantially parallel conductive segments. The set of segments 131 are conductively coupled to each other, as are the set of segments 132. The segments of set 131 and the segments of set 132 are arranged interstitially adjacent to each other and are conductively isolated from each other. The set of segments 131 and the set of segments 132 thus act as the plates of a capacitor whose capacitance varies as the sensor 100 is flexed or perturbed. One set of segments 131 is coupled to the element 120 and the other set of segments 132 is coupled to the conductive element 135.

The conductive elements 125 and 135 are coupled by a wire 140, or other suitable electrically conductive member, thereby completing a closed circuit which includes the conductive elements 120 and 130.

In an exemplary embodiment, the non-contact strain sensor 100 is fabricated using thin film semiconductors, such as described in U.S. Pat. No. 7,082,834 (hereinafter the '834 patent), which is entitled “Flexible Thin Film Pressure Sensor” and is incorporated herein by reference in its entirety. Accordingly, the conductive elements 120 and 130 are piezoresistive and their resistances will vary as the substrate is flexed. This, in turn, will cause variations in the sensor's spectral response which can be detected to monitor the degree of deformation of the sensor.

An exemplary sensor in accordance with the present invention is approximately 1.5″×1.5″, although a wide range of dimensions is possible. Using well-known fabrication techniques, each sensor can be fabricated individually or as part of an array of multiple devices fabricated together on the same substrate which may or may not be later separated.

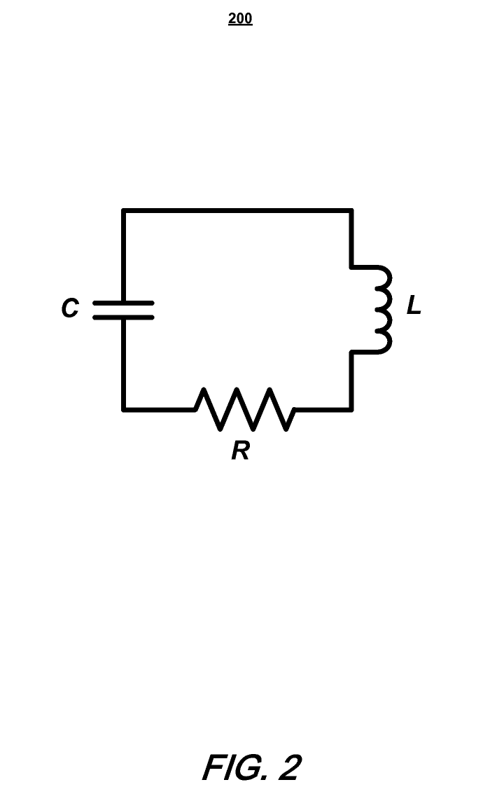

FIG. 2 is a schematic diagram of a lumped-element electrical circuit representation of the sensor 100 of FIG. 1. The lumped element C represents the capacitance of the element 130, primarily, as well as any parasitic capacitance attributable to the other elements of the sensor. The lumped element L represents the inductance of the sensor circuit, which is attributable primarily to the element 120 and the lumped element R represents the resistance of the circuit, which is also attributable primarily to the element 120.

As is well-known, the series resonant frequency fₛ for the RLC circuit of FIG. 2 is:
fₛ=1/2π\sqrt{LC} (1)
As such, as C and/or L vary, the series resonant frequency of the sensor will vary.

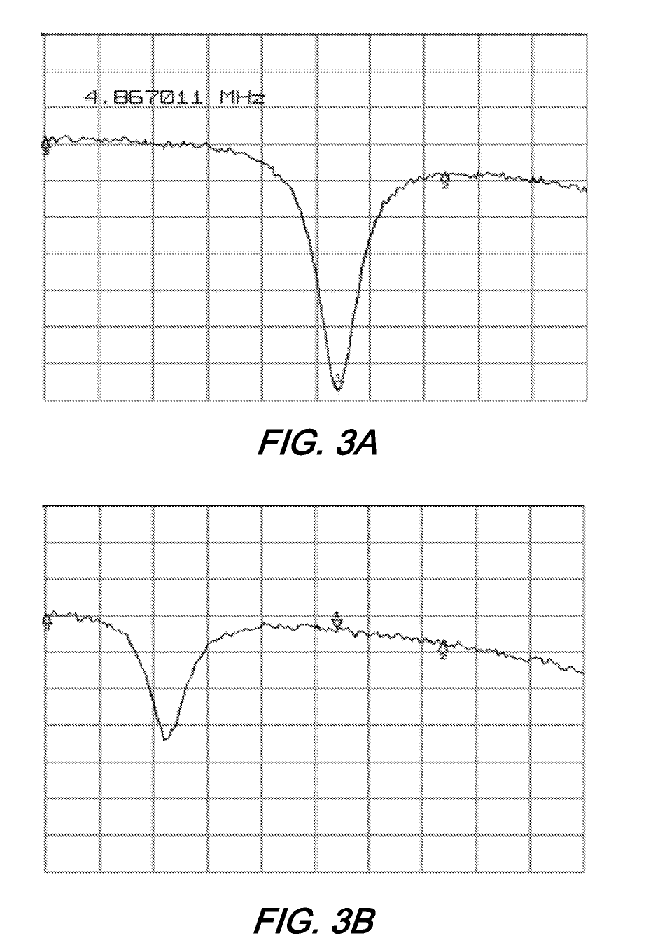

FIGS. 3A and 3B are spectral graphs of amplitude vs. frequency illustrating the variation in series resonant frequency for an exemplary embodiment of a strain sensor in accordance with the present invention. As shown in FIG. 3A, the resonance frequency for the sensor in an unstretched state is measured to be approximately 4.867 MHz, whereas in the stretched state it is approximately 3.187 MHz.

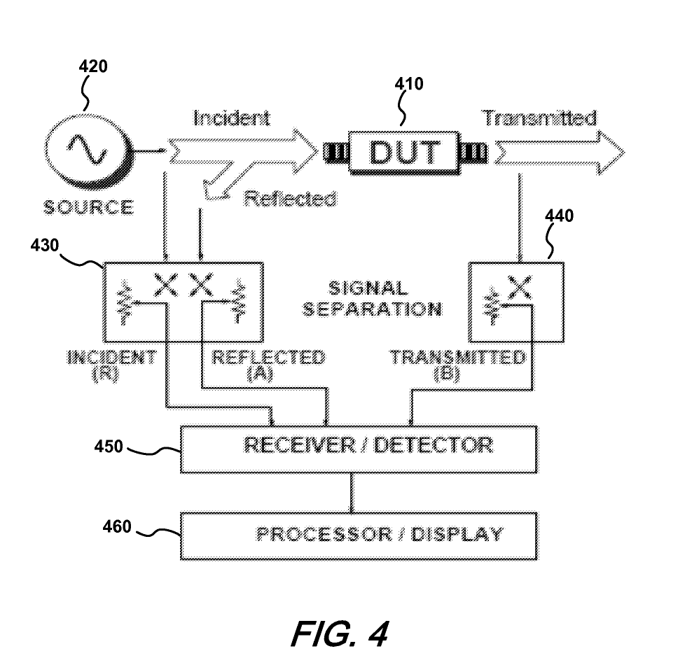

The results illustrated in FIGS. 3A and 3B can be obtained using an arrangement such as that shown in FIG. 4. A sensor 410, designated as the device under test (DUT), is exposed to an incident RF signal from an RF signal source 420. A portion of the incident RF signal will be reflected by the sensor 410, whereas a portion will be transmitted. A first signal receiving module 430 monitors the incident signal, while a second signal receiving module 440 monitor the transmitted signal. The first receiving module 430 may also monitor the reflected signal. The received signals are then provided to a receiver/detector block 450 for detection. A processor/display block 460 processes the received signals and displays measurement results. The RF source 420 is controlled so as to step-wise sweep through a range of frequencies of interest. At each frequency step, the incident and transmitted signals are monitored and processed. Dividing the magnitude of the transmitted signal by the magnitude of the incident signal and plotting over frequency yields spectral graphs such as those of FIGS. 3A and 3B.

As an alternative to monitoring and processing the incident and transmitted signals, the incident and reflected signals can be monitored and processed, in a similar manner, to provide an indication of the spectral response of the sensor 410.

In applications using multiple sensors, it may be preferable to design the sensors so as to have distinct resonant frequencies (stretched and unstretched) so as to distinguish their emissions from each other, particularly if more than one sensor is to be illuminated by the same RF signal source. This can be done by adjusting the L and C parameters of the sensor circuits accordingly, such as by varying the lengths or numbers of conductive elements of the sensors.

When the sensor is deformed, in addition to a shift in resonant frequency, a change may also occur in the amplitude of the sensor's transmitted signal. As is well understood, as the L, C and/or R parameters change, the spectral response of the sensor (i.e., the shape and/or amplitude of the graphs of FIGS. 3A and B) will vary accordingly. For an exemplary sensor, the amplitude under the unstretched condition may be approximately 4 dB (e.g., the reflected signal relative to the background), whereas the amplitude under a stretched condition is approximately 12 dB. This translates into an approximately 1.5 order of magnitude change in amplitude between the unstretched and stretched conditions that can be registered by the sensor. This change in amplitude can be used as an alternative or in addition to the change in resonant frequency to provide an indication of deformation of the sensor.

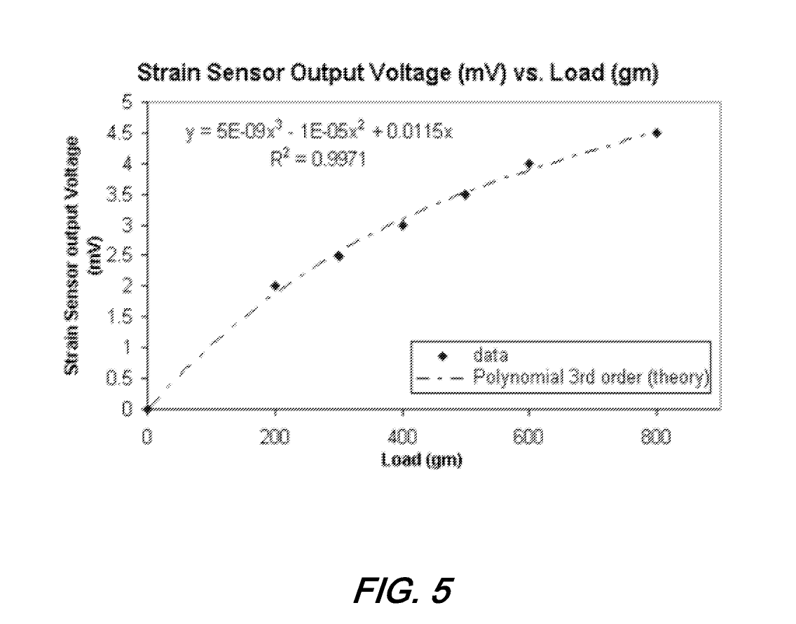

FIG. 5 is a graph showing the relationship between the output voltage of an exemplary strain sensor in accordance with the present invention and the load applied thereto. The diamonds in FIG. 5 represent actual measurements of an exemplary device (using an RF dip meter, for example, such as an MFJ-201), whereas the dashed line represents the third order polynomial curve which best fits the data.

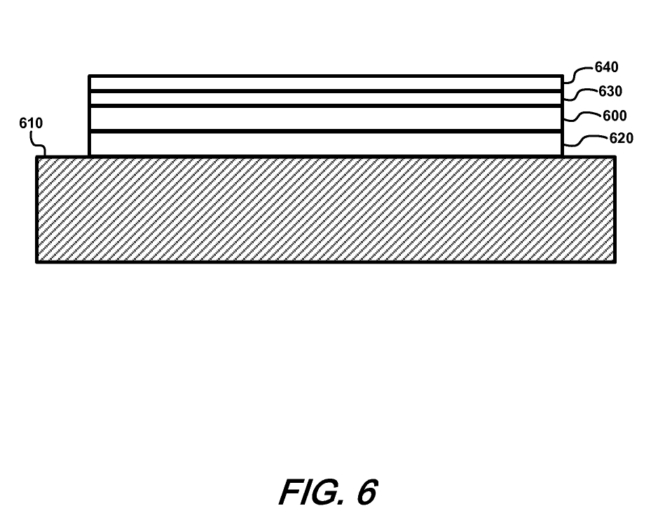

FIG. 6 is a cross-sectional view of an exemplary arrangement of a strain sensor 600, in accordance with the present invention, on a structural member 610 of interest, such as steel beam. For clarity, the sensor 600 is shown as being of one layer, although it may be implemented with multiple layers of material. For example, an exemplary embodiment of a sensor 600 is implemented as a macro 680 nm semiconductor thin film device fabricated on a 50 micron thin flexible polymer substrate. The substrate can be formed using Kapton or plastics, for example. The strain-sensing element is comprised of n-type doped a-Si:H/SiNx with Al top coat metallization. The total device structure thickness is approximately 51 micron. The sensor 600 can be fabricated as described in the '834 patent.

As shown in FIG. 6, the sensor 600 is applied over a layer 620 of insulating material on the structural member 610. The layer 620 can be implemented using SiNx having a width of 100 nm-500 nm. An encapsulating layer 630 of material is placed over the sensor 600 to protect the sensor which can then be covered by a layer of paint 640. The layer 630 can also be implemented using SiNx having a width of 100 nm-500 nm.

The use of thin film technology or the like makes it possible to implement a sensor of the present invention with small thicknesses, allowing the sensor to be placed in space-restricted environments. Additionally, the sensor is lightweight, with minimal impact on the overall weight of the structure to which it is applied, even when multiple sensors are used.

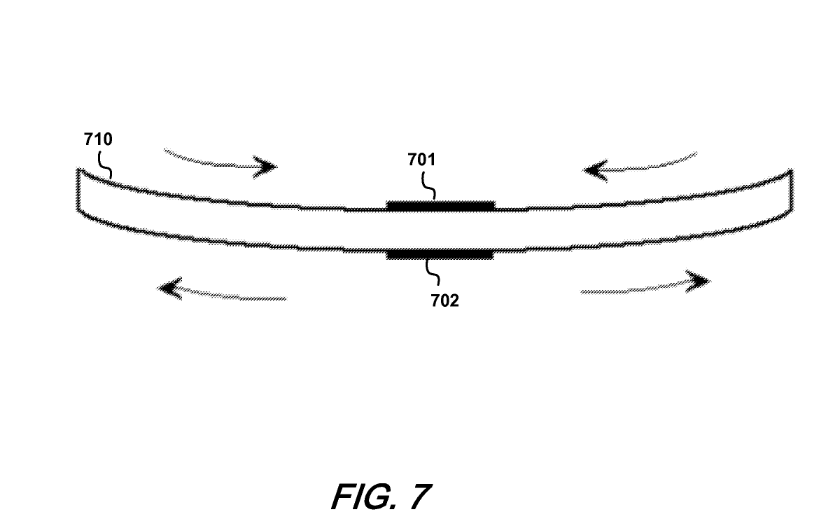

FIG. 7 is a schematic illustration of an exemplary arrangement of strain sensors 701 and 702, in accordance with the present invention, on a structural member 710 undergoing deformation. In the arrangement of FIG. 7, the sensors 701 and 702 are placed on opposite sides of the member 710, substantially in alignment with the direction of deformation of the member. Such an arrangement will cause the sensors 701 and 702 to respond differentially to the same deformation, i.e., the resonance frequency of one sensor will increase whereas the resonance frequency of the other sensor will decrease. By comparing the resonant frequencies of the sensors 701 and 702, a more pronounced indication of the deformation is thus provided than would be possible with only one sensor.

By thus providing an indication of deflection, sensors in accordance with the present invention can be used to monitor the condition of structural members. For example, when material corrosion and fatigue occur, such as the rusting of metallic members, the Young's modulus of the member will decrease, thus allowing the member to deflect more than an unimpaired member for a given load. By thus monitoring the degree of deflection of a structural member using the sensor, an indication is thus provided of the condition (e.g., degree of corrosion) of the member.

Sensors implemented in accordance with the principles of the present invention can be used in a wide variety of applications which entail monitoring the condition of structural material or supports, including for example weapon systems and munitions, land, air or sea vehicles, unmanned systems, bridges, buildings, and aerospace, among others.

It is to be understood that the above-described embodiments are merely illustrative of the instant invention and that many variations of the above-described embodiments can be devised by those skilled in the art without departing from the scope of the invention. For example, in this Disclosure, numerous specific details are provided in order to provide a thorough description and understanding of the illustrative embodiments of the instant invention. Those skilled in the art will recognize, however, that the invention can be practiced without one or more of those details, or with other methods, materials, components, etc.

What is claimed is:

1. A method of monitoring a deflection of a structural member comprising:
transmitting a first radio frequency (RF) signal toward a closed circuit comprising an inductance and a capacitance coupled in series, at least one of the inductance and capacitance varying as a function of the deflection of the structural member;
receiving a second RF signal from the closed circuit;
determining a resonant frequency of the closed circuit based on the second RF signal; and
comparing the resonant frequency to a reference resonant frequency to provide an indication of the deflection of the structural member.

2. The method of claim 1, comprising:
determining the reference resonant frequency of the closed circuit when the closed circuit is in a reference stressed state.

3. The method of claim 1, comprising:
determining an amplitude of the second RF signal; and
comparing the amplitude of the second RF to a reference amplitude to provide a further indication of the deflection of the structural member.

4. A method of monitoring a corrosion condition of a structural member comprising the method of claim 1, wherein the deflection of the structural member is indicative of the corrosion condition of the structural member.

5. The method of claim 4, wherein the structural member is embedded in a vehicle.

6. A strain sensor comprising:
a flexible substrate; and
a circuit fabricated on the substrate, the circuit comprising an inductive element and a capacitive element coupled in series, at least one of an inductance and a capacitance of the circuit varying as a function of the deflection of the substrate.

7. The strain sensor of claim 6, wherein the inductive element includes a first plurality of conductive segments coupled in a spiral pattern and the capacitive element comprises a second plurality of conductive segments arranged in parallel to a third plurality of conductive segments.

8. The strain sensor of claim 6, wherein a first terminal of the first plurality of conductive segments is coupled to the second plurality of conductive segments and a second terminal of the first plurality of conductive segments is coupled to the third plurality of conductive segments.

9. The strain sensor of claim 6, wherein the second terminal of the first plurality of conductive segments is coupled to the third plurality of conductive segments via a wire.

10. The strain sensor of claim 7, wherein the first, second and third plurality of conductive segments include piezoresistive elements.

11. A system for monitoring a corrosion condition of a structural member comprising the strain sensor of claim 6, wherein the deflection of the structural member is indicative of the corrosion condition of the structural member.

12. The system of claim 11, wherein the structural member is embedded in a vehicle.

13. A strain monitoring system comprising a plurality of strain sensors in accordance with claim 6, wherein each strain sensor is individually readable.

14. The system of claim 13, wherein a first of the plurality of strain sensors has a first resonant frequency and a second of the plurality of strain sensors has a second resonant frequency.

15. The system of claim 14, comprising a reader device which determines the resonant frequencies of the first and second strain sensors.
